(19) United States
(12) Patent Application Publication
(10) Pub. No.: US 2003/0195878 A1
(43) Pub. Date: Oct. 16, 2003

(54) Comparison of source files

(76) Inventor: Ralf Neumann, Dinslaken (DE)

Correspondence Address: BAZERMAN & DRANGEL, P.C., 60 EAST 42ND STREET, SUITE 820, NEW YORK, NY, 10165, US

(21) Appl. No.: 10/410,316

(22) Filed: Apr. 9, 2003

(30) Foreign Application Priority Data
Apr. 10, 2002 (DE) DE 102 15 852.5
Nov. 6, 2002 (EP) EP 02 024 709.4

(51) Int. Cl. G06F 17/30

(52) U.S. Cl. 707/3

(57) ABSTRACT

A method of comparing two source files containing database queries is described in which the database queries are ascertained from the two source files and in which the ascertained database queries from a first source file are compared with the ascertained database queries of a second source file. A quick and efficient analysis of different program versions is achieved by ascertaining the syntax of each database query with the help of a syntax analysis, by comparing the syntax of the database queries of the source files with one another and by presenting the results of the comparison.

### PRIORITY

This application claims priority of German patent application number 102 15 852.5, filed on Apr. 10, 2002 and of European patent application number 02 024 709.4, filed on Nov. 6, 2002, both pending.

### FIELD OF THE INVENTION

The present invention relates to a method of comparing two source files comprising database queries in which the database queries are determined from the two source files and in which the ascertained database queries from a first source file are compared with the ascertained database queries in a second source file. In addition, the invention concerns a comparison device comprising a reader for reading source files and an extractor for extracting database queries from source files.

### BACKGROUND OF THE INVENTION

Database queries from external sources are coded to access databases, particularly relational databases such as IBM's DB2. The coded query text of a database query comprises different elements. Database queries are carried out through a standardized interface, the Structured Query Language (SQL) interface. Here SQL queries are transmitted to the database system and processed by the database system. These SQL queries can consist of a number of query elements, whereby, for example, the elements “Cursor Name”, “Statement Type” (Select, Insert, Update, Delete), “Tables”, “Joins”, “Predicates”, “Select, Update and Insert Columns”, “Select Option Text” and “Select Option Columns” can be used.

On a query of a database using SQL, actions are triggered in the database system that enable the database query to be answered. The response times for database queries can vary greatly depending on the query elements that are coded. It is desired here that the SQL queries are optimized to enable the shortest possible response times.

Programs that work with the data records of the databases are changed over the course of time. A change in the SQL queries can accompany the change in the programs and this may eventually lead to changes to the response times. In some cases, the response times are affected negatively and are no longer tolerable. It is then necessary to ascertain which SQL queries are responsible among others for the extended response times.

### PRIOR ART

For this purpose, it is known to compare the database queries of the original program with those of the new program. To do this, each database query of the original program is determined sequentially. Within the new program, a database query residing at the same position is looked for. Then, the query text of the two database queries are compared. However, the database queries in the new program version are frequently simply moved to another position. For example, a database query that appears at the beginning of the original program, may simply appear at the end of the new program. A database query displacement of this kind cannot be determined using prior art because of the sequential method that is used to locate the database query, which requires a one to one relationship, i.e., the first database query in an original program is compared with the first database query in the new program, and the following database queries are checked in the same way.

It may also happen that the query text of a database query has been changed, but not its semantics. However, known methods of comparison do not recognize this and the comparison shows that the database queries have changed. Finally, it may be that database queries have changed only slightly in their semantics but considerably in their syntax, which is why prior art shows these as changed.

To discover the database queries that cause the long response times, it is traditionally necessary to subject all changes that are found to a manual examination, which can cause considerable effort because of the problems presented above in searching for changed database queries.

Accordingly, it is an object of the present invention to overcome the aforesaid drawbacks and to make available an efficient comparison of source files comprising database queries. Further objects and advantages will become apparent from a consideration of the ensuing description and drawings.

### SUMMARY OF THE INVENTION

According to the present invention, the syntax of each database query is determined with the help of a syntax analysis, and the syntax of all database queries of the source files are subsequently compared with one another. The sources for ascertaining the syntax can be, for example, the program source code, the database request module (DBRM), the DB2 catalog information, as well as trace files comprising query text.

The syntax of a database query reflects the individual elements of the database query with regard to its grammatical rules and its composition. Changes to the syntax mean a change in the composition or sequence of elements. However, this does not necessarily lead to a change in the semantics.

An analysis of the syntax is carried out, for example, with the help of a parser program. The syntactical elements of the database query are ascertained here. In accordance with the present invention, all database queries from a first source file are broken down into their syntactical elements and all database queries of a second source file are broken down into their syntactical elements. All syntax of the database queries of the first source file are compared with all the syntax of the database queries of the second source file. Any differences that occur can now be evaluated better because changes in the positioning of the syntactical elements within a database query are recognized. Changes in the sequence of elements do not lead to a change in the syntax, which is why changed query texts are not taken into account in the comparison.

A database query is composed of syntactical elements that can be allocated to different categories. To guarantee that on a comparison syntactical elements of the appropriate categories are compared with one another, according to a preferred embodiment of the invention, it is proposed that syntactical elements of the database queries are saved in categories.

According to another preferred embodiment of the invention, the syntactical elements of the combined database queries that correspond with one another are compared with one another. For example, individual parts of an SQL query are compared with one another. In accordance with the SQL specifications, queries and elements are allocated to defined categories. If the query text of the database query is examined, the individual syntactical elements are ascertained and they are assigned to the individual categories.

To guarantee that each database query of the first source file is compared with each database query of the second source file, it is preferred that all possible combinations of all database queries within two source files are compared using weights to measure comparability. This can, for example, ultimately occur after all database queries for both source files have been broken down into their syntactical elements, which are assigned to categories and saved in a table.

When a database query is carried out, in particular an SQL database query, different elements result in different response times. For example, a changed SELECT command has less effect than a changed WHERE command. For this reason it is proposed that the syntactical elements are given weights. According to another preferred embodiment of the invention, the significance between the syntactical elements of the combined database queries is measured with the help of the weights. This means that changes in the syntactical elements that have less effect on the response time can be weighted less than those that have a greater effect on the response time. In this way, it is possible to ascertain whether changes that are found are likely to have an effect on the performance of a database query.

In order to be able to carry out the iteration through the database queries quickly and to have a direct access to the database queries that are found and to their syntax, according to another preferred embodiment of the invention, it is proposed that an identifier designating the appropriate syntax for each ascertained database query is stored in a table. Preferably, an assigning identifier assigning the database query of the source file can also be saved. Preferably, in addition a similarity value showing the results of a comparison with another database query can be stored.

The syntax of a database query is stored preferably in a table together with its syntactical elements. In order to be able to access this table, the identifier that designates the syntax is saved in the table. In addition, immediate access to the database query is possible and its position in the source file can be determined if the assignment identifier is saved. Finally, if the results of a comparison are saved it is possible to ascertain whether a similar or the same database query was found in the second source file. For example, on a comparison of a database query of a first source file with all database queries of a second source file, an absolutely different database query is found in a first step. The result of the comparison is saved as a similarity value. In the next step, a database query is found in the second source file that has a certain similarity with the database query of the first source file, whereby this similarity is saved as the result of the comparison because it is greater than the similarity that was found previously. Finally, a database query is found in the second source file that corresponds completely with the database query of the first source file. Because the similarity of these two source files is greater than the similarity that was previously found, this is saved as the similarity value.

According to another preferred embodiment of the invention, for every database query combination for both sources, the similarity value is computed and saved in a matrix until every database query of one source has been compared to every database query of the second source. By saving the similarity value in the matrix, all database queries in the second source file can be found that have the greatest similarity with the database queries of the first source file. This proposes a facility to distinguish identical and similar database queries from those that are significantly changed or new.

Because different syntactical elements have different weights, according to another preferred embodiment of the invention it is proposed that each combination of database queries is assigned a similarity value with the help of the weighted differences. If the two database queries differ in syntactical elements that have a slight effect only on the response time, that leads to them still being similar. If a difference is found in syntactical element that can have a great effect on the response time, the effect is that the database queries are only slightly similar. This means that only slight changes in the query text, which contains syntactical elements which have a material effect on the response time, lead to a lower level of similarity of database queries that may appear similar at first glance.

In order to be able to facilitate the comparison process, according to another preferred embodiment of the invention, it is proposed that identical database queries, i.e., those that match, are presented initially as identical. All database queries of the first source file for which database queries in the second source file have been found and evaluated as equal (and vice versa) are presented as identical. These do not have to be checked any longer because they do not have any effect on changed response times of the database.

Even very similar database queries may have no effect on the response time of the database, which is why according to another preferred embodiment of the invention, it is proposed that equivalent combined database queries are presented as identical. Equivalent means that only changes to syntactical elements that have no effect on the response time are differentiated between the database queries. These database queries can be presented as identical.

In order to be able to restrict the number of database queries to be checked by a database administrator, it is preferred that a limit value is fixed and that the similarity value is measured against the limit value. The database queries can then be presented as similar or dissimilar with the help of the limit value. If the similarity value of a pair of database queries exceeds the limit value, these database queries are presented as changed. If the similarity value is below a limit value, it can be concluded that these database queries are new.

Finally, according to another preferred embodiment of the invention, the two source files can be compared with each other in their totality, so that it is proposed that the total deviation of the database queries of the first source file from the second source file is determined. This total deviation is a measure of how many of the database queries in a second source file have changed from those of a first source file, and to what extent.

The invention further relates to a comparison device comprising one or several readers that read the source files and extractor devices that extract database queries from source files. The readers typically are functional blocks that read the source files, that is, ascertain their contents. The extractor devices are functional blocks that extract the database queries from the contents of the source files.

An efficient and exact determination of changed database queries is achieved by providing both one or several analyzers that analyze the syntax of a database query and one or several comparators that compare the syntactical elements of the database queries. The analyzers, which can, for example, be parsers, typically are functional blocks that analyze the database queries and extract their syntax. To do this the analyzers can break down the syntax into syntactical elements and in this way make them available to the comparators. Comparators each receive two syntax and compare them with one another. With the help of the comparators, it is possible to compare each database query of the first source file with each database query of the second source file with regard to their syntax.

According to a preferred embodiment of the invention, the comparison device may further comprise one or several storage means for data, e.g., memory. Memory is a functional unit that stores data. The memory can be used for storing the syntactical elements of the database queries. With the help of the memory, it is possible to subsequently access the syntactical elements of each database queries.

According to another preferred embodiment of the invention, the comparison device may further comprise one or several weighting systems to weight the findings of the comparators. The weighting systems typically are functional units that can combine findings with factors and serve to assign weights to the syntactical elements. These weights refer to how far a syntactical element has an effect on the response time of a database on a database query.

According to another preferred embodiment of the invention, the comparison device may further comprise elimination systems to evaluate the weighted findings. The elimination systems are functional elements that assign a similarity value to the individual database queries. With the help of the elimination systems, it is possible to differentiate similar from dissimilar database queries and in this way to limit the number of database queries to be examined.

In the following detailed description, an example of the invention is explained in detail by means of drawings showing embodiments.

### BRIEF DESCRIPTION OF THE DRAWINGS

FIG. 1 illustrates the course of a process in accordance with the present invention.

FIG. 2 illustrates a device in accordance with the present invention.

FIG. 3 illustrates syntactical elements that have that been broken down and stored in their respective categories and shows how they are compared for two program queries to determine the similarity values between them.

FIG. 4 illustrates how all database queries of two program sources are compared with each other in order to determine the similarity and find corresponding pairs irrespective of their location in the two programs.

### DETAILED DESCRIPTION OF THE INVENTION

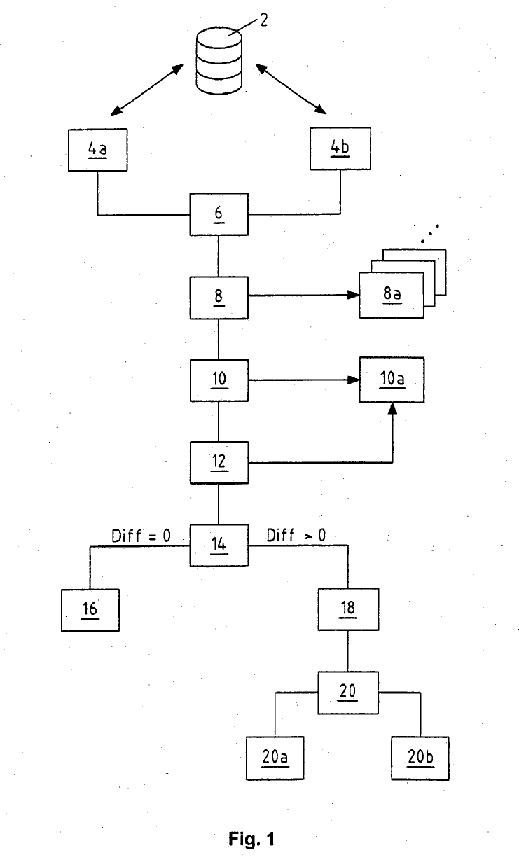

FIG. 1 shows a database 2 that has a multiplicity of data. This data can be extracted from the database with the help of Structured Query Language (SQL) queries. Original program source code 4A and revised program source code 4B work with database 2 with the help of the SQL queries. The processing times in programs 4 might differ from one another depending on whether changes were made to the SQL queries contained in programs 4. If an old program source 4a is replaced by a new program source 4b, it is desirable to determine the differences in the SQL queries between program sources 4a and 4b so that an analysis of the altered SQL queries is possible.

For this purpose, the respective programs 4a and 4b are analyzed in step 6 and all SQL queries are extracted. This is done first for the old program source 4a and next for the new program source 4b. In this illustration, two program source codes are used However, the sources for extracting in step 6 can also be, for example, the database request modules (DBRM) of programs 4, the DB2 catalog information (collection, package and version), as well as trace files comprising database queries.

In step 8 all extracted SQL queries are broken down into their syntactical elements. A parser is used for this purpose that breaks the SQL queries down into their respective syntactical elements. A table is drawn up for each SQL query contained in program 4a and program 4b in which the syntactical elements are stored in categories. In addition, there is a reference to the position of the SQL query in the programs 4.

After all the SQL queries have been broken down in step 8 and stored in the individual tables 8a, step 10 prepares a matrix 10a. For all SQL queries of programs 4a, 4b, this preparation includes the code of the parser table 8a, the position of each SQL query in the programs 4a, 4b, and a switch to eventually show whether a SQL query corresponds to another SQL query, later used to eliminate corresponding SQL queries.

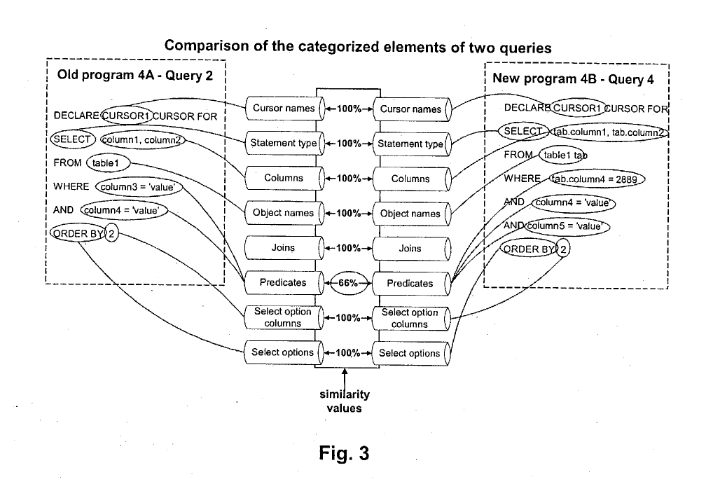

In step 12, the elements of individual SQL queries that are filed in Table 8a are compared with one another. Here, the elements of all SQL queries of the old program source 4a are compared with the elements of all SQL queries of the new program 4b. For this purpose, for example, all syntactical elements like Cursor Name, Statement Type, Tables, Joins, Predicates, Select, Update and Insert Columns, Select Option Text and Select Option Columns are compared with one another. The similarity value is determined for each combination of corresponding syntactical elements of all SQL queries of the old program source 4a with all SQL queries of the new program source 4b. The similarity values for the syntactical elements are filed in the matrix 10A. FIG. 3 illustrates the comparison of the categorized elements for two statements.

In step 14, after the matrix 10a has been filled with all similarity values for all comparisons of the syntactical elements, SQL queries are compared with each other and, using the matrix 10a, a percentage deviation and a weighted evaluation are determined for all query combinations. With the percentage deviation, the differences between the individual SQL queries are observed absolutely. With the weighted evaluation, different weightings are stipulated for individual syntactical elements and any differences that occur are weighted using these weightings. This means that individual syntactical elements can have less effect on the weighted deviation than others. The reason for this is that different syntactical elements of an SQL query have different effects on the performance of the SQL queries. For example, a change in the sequence of a SELECT query brings about a negligible change to the performance of the SQL query, whereas a changed WHERE condition in an SQL query brings about a greater change to the performance of the SQL query.

After the differences between the individual SQL queries of program 4a and those of program 4b have been introduced in step 14, these differences are evaluated. If pairs of SQL queries are found in programs 4a and 4b that do not deviate from each other, their difference is presented as 0. The corresponding switches in matrix 10a for these pairs are marked in step 16 and they can be eliminated from further considerations.

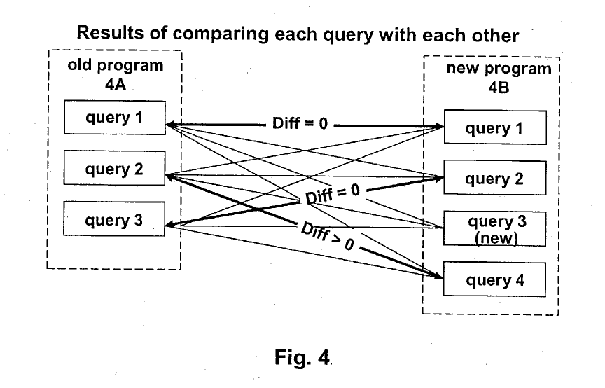

All pairs marked as not corresponding (their difference is greater than 0) are evaluated in step 18, whereby for each SQL query of the old program 4a the SQL query of the new program 4b is looked for that has the greatest correspondence. FIG. 4 illustrates how all combinations of all SQL queries of programs 4a and 4b are compared with each other to find corresponding and not corresponding pairs.

After all SQL queries have been examined and the best pairs ascertained in step 18, a threshold value comparison is carried out to determine the relevance of the changes for the best pairs in step 20. For this purpose a threshold value is stipulated that determines the lowest deviation between found pairs that are evaluated as no longer corresponding. All SQL queries that have changed in part, but whose deviation level is lower than the threshold value, are presented in step 20a as partly corresponding and can be ignored.

Furthermore, the weighting of the syntactical elements of the SQL queries plays an important part. The query text of a SQL query in a program 4b can in fact differ greatly from a program 4a, but these two SQL queries differ only in a syntactical element that has a slight effect on the performance of the program. A deviation of this type can be ignored and these pairs are also presented in step 20a.

If a deviation that lies above the stipulated threshold value is discovered in step 20 in pairs that were found to have the best possible correspondence, these SQL query pairs are presented in step 20b. All SQL queries in program 4b, or for which no corresponding queries can be found in program 4a are presented as new in program 2b. Thus, SQL queries presented in step 20b should be considered for subsequent performance evaluation.

In summary, it is highly probable that relevantly changed and new SQL queries 20b will tend to alter the performance of a new program 4b as compared with the old program 4a more than those SQL queries that have insignificantly changed 20a or have not changed at all 16. The comparison in accordance with the present invention makes it possible to guarantee a preliminary selection of the SQL queries that facilitate the performance evaluation of a new program as compared with an old program.

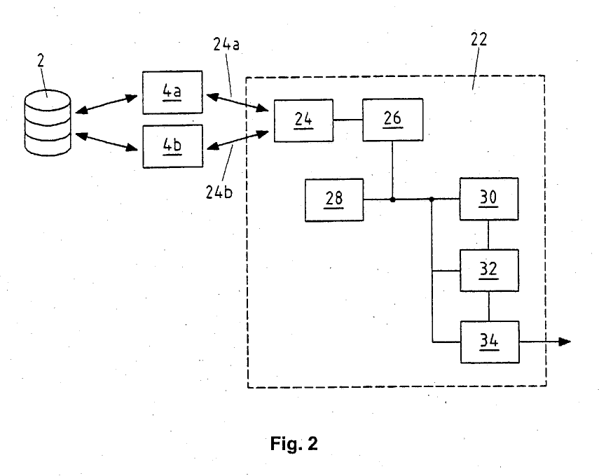

FIG. 2 shows a comparison device in accordance with the present invention. Programs 4a and 4b work on a database 2, in particular a DB2 database from IBM, with the help of SQL queries. If a new program 4b is introduced and an old program 4a replaced, it frequently happens that the performance of the new program 4b changes considerably as compared with the old program 4a. Among the reasons for this is that the SQL queries have changed from program 4a to program 4b. A comparison device 22 is proposed to facilitate an analysis of the SQL queries.

The reader devices 24 access the SQL queries of programs 4 through interfaces 24a, 24b. The SQL queries of the respective programs 4 that are ascertained through the reader devices 24 are broken down into their syntactical elements through the extractor devices 26. A table with the ordered syntactical elements of the respective SQL query is stored in memory 28 for each SQL query. This means that memory 28 contains tables with all SQL queries for the two programs 4a and 4b, whereby the tables store the SQL queries ordered in accordance with syntactical elements.

Comparator devices 30 access the memories 28 and read the tables with the SQL queries. With the help of comparator devices 30 SQL queries of program 4a are compared with SQL queries of program 4b. In the comparison all the SQL queries of each program are compared with one another. If the comparator devices 30 find SQL queries that correspond with regard to their syntactical elements, these SQL queries are presented as being identical with the help of the eliminator devices 32. SQL queries that are presented as being identical no longer have to be taken into account in an analysis of differences between the programs 4a and 4b.

The differences in the SQL queries that are ascertained through the comparator devices 30 are weighted with the help of the weighting systems 34. This means that differences in the individual syntactical elements are weighted differently. After all differences have been weighted a search takes place for all the pairs of SQL queries that are most similar in the two programs 4a and 4b. The degree of similarity between the found pairs is evaluated in the eliminator devices 32 and compared with a threshold value. If pairs of SQL queries are similar to one another, i.e. their weighted differences are below a defined threshold value, they are presented as being partially identical. SQL queries that are hardly identical, i.e. their weighted differentiation value is above the threshold value, are presented as being new or deleted.

In an analysis of the differences between programs 4a and 4b the SQL queries that are presented as new or deleted must be examined first. This makes it possible to determine differences between two program versions quickly and efficiently and enables any performance problems that occur to be remedied quickly.

Although the description above may contain many specifications, these should not be construed as limiting the scope of the invention but as merely providing illustrations of some of the presently preferred embodiments of this invention. Thus, the scope of the invention should be determined by the appended claims and their legal equivalents rather than by the examples given.

List of Reference Numerals

| | |
|---|---|
| 2 | Database |
| 4a, b | Program sources containing queries |
| 6 | Extracting |
| 8 | Breaking down |
| 8a | Parser tables |
| 10 | Setting up matrix |
| 10a | Matrix |
| 12 | Comparing elements |
| 14 | Comparing query texts |
| 16 | Marking as corresponding |
| 18 | Ascertaining best pairs |
| 20 | Comparison of threshold value |
| 20a | Partly corresponding |
| 20b | Relevantly changed or new |
| 22 | Comparison device |
| 22a | Interfaces |
| 24 | Reader device |
| 26 | Extractor device |
| 28 | Memory |
| 30 | Comparator device |
| 32 | Eliminator device |
| 34 | Weighting system |

I claim:

1. A method of comparing a first source file with a second source file, said first and second source files each comprising one or several database queries, wherein said database queries are ascertained from said first and second source files and wherein the ascertained database queries of said first source file are compared with the ascertained database queries of said second source file, which method comprises:
performing a syntax analysis to ascertain a syntax of each of said database queries;
performing a comparison of said syntax of said database queries with one another; and
presenting the results of said comparison.

2. The method of claim 1, wherein each database query of the first source file is combined with each database query of the second source file to form combined database queries.

3. The method of claim 1, wherein said syntax of said database queries comprises syntactical elements.

4. The method of claim 3, wherein said syntactical elements are stored in categories.

5. The method of claim 2, wherein said syntax of said database queries comprises syntactical elements and wherein a comparison of the syntactical elements of the combined database queries that correspond to one another is performed.

6. The method of claim 2, wherein said syntax of said database queries comprises syntactical elements and wherein a weight is assigned to each syntactical element and wherein the weighted difference between the syntactical elements of the combined database queries is used to determine a similarity value with the help of said weights.

7. The method of claim 5, wherein a weight is assigned to each syntactical element and wherein the weighted difference between the syntactical elements of the combined database queries is used to determine a similarity value with the help of said weights.

8. The method of claim 1, wherein for each ascertained database query an identifier marking the appropriate syntax, an assignment identifier assigning the database query of the source file, and a similarity value showing the results of a comparison with another database query is stored.

9. The method of claim 2, wherein a similarity value is assigned to each combination of database queries with the help of weighted differences.

10. The method of claim 2, wherein identical combined database queries are presented as identical.

11. The method of claim 2, wherein equivalent combined database queries are presented as identical.

12. The method of claim 9, wherein similar combined database queries are presented with their similarity value.

13. The method of claim 6, wherein a threshold value is stipulated and the similarity value is measured against the threshold value and by presenting the database queries as similar or dissimilar with the help of the threshold value.

14. The method of claim 7, wherein a threshold value is stipulated and the similarity value is measured against the threshold value and by presenting the database queries as similar or dissimilar with the help of the threshold value.

15. The method of claim 9, wherein a threshold value is stipulated and the similarity value is measured against the threshold value and by presenting the database queries as similar or dissimilar with the help of the threshold value.

16. The method of claim 1, wherein the total deviation of the database queries of the first source file from the second source file is ascertained.

17. A device for comparing two source files comprising database queries, which comprises:
a reader for reading source files;
an extractor for extracting database queries from source files; and
an analyzer for analyzing the syntax of a database query and
a comparator for comparing the syntactical elements of the database queries.

18. The device of claim 17, further comprising a memory for storing the syntactical elements of the database queries.

19. The device of claim 17, further comprising a weighting system for weighting the results of the device.

20. The device of claim 17, further comprising an eliminator device for evaluating the weighted results.
